(19) United States
(12) Patent Application Publication
(10) Pub. No.: US 2025/0192838 A1
(43) Pub. Date: Jun. 12, 2025

(54) DIRECTION-BASED COMMUNICATION

(71) Applicant: Telefonaktiebolaget LM Ericsson (publ), Stockholm (SE)

(72) Inventors: Andreas NILSSON, Göteborg (SE); Sam AGNEESSENS, Torslanda (SE); Magnus NILSSON, Kungsbacka (SE); Mikael COLDREY, Borås (SE)

(73) Assignee: Telefonaktiebolaget LM Ericsson (publ), Stockholm (SE)

(21) Appl. No.: 18/867,578

(22) PCT Filed: May 23, 2022
(86) PCT No.: PCT/EP2022/063890

§ 371 Date: Nov. 20, 2024

(51) Int. Cl. H04B 7/06; H04B 7/0452

(52) U.S. Cl. CPC H04B 7/0617; H04B 7/0452

(57) ABSTRACT

A method is disclosed for a communication device, wherein the communication device comprises a visual sensor. The method comprises using the visual sensor for detecting another communication device, wherein the other communication device is detected by distinguishing an identifier which is visually arranged on the other communication device. The method also comprises estimating a direction associated with the communication device and the other communication device. and causing subsequent communication between the other communication device and the communication device to be based on the estimated direction. In some embodiments, causing subsequent communication between the other communication device and the communication device to be based on the estimated direction comprises reducing an amount of potential beams for the communication based on the estimated direction. Corresponding computer program product. apparatus and communication device are also disclosed. Also disclosed is a communication device having an identifier which is visually arranged on the communication device.

### TECHNICAL FIELD

The present disclosure relates generally to the field of wireless communication. More particularly, it relates to approaches for direction-based communication.

### BACKGROUND

Many wireless communication approaches apply direction-based communication. One example of direction-based communication involves beam-formed communication (i.e., beam-formed transmission and/or beam-formed reception), for which beam selection may be applied to enable the beam-formed communication to perform as intended.

The process of selecting beam(s) for transmission and/or reception typically entails overhead signaling as well as delays, which may have negative impact on the communication performance (e.g., decreased throughput, increased latency, etc.).

Therefore, there is a need for new approaches to direction-based communication.

### SUMMARY

It should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Generally, when an arrangement is referred to herein, it is to be understood as a physical product; e.g., an apparatus. The physical product may comprise one or more parts, such as controlling circuitry in the form of one or more controllers, one or more processors, or the like.

It is an object of some embodiments to solve or mitigate, alleviate, or eliminate at least some of the above or other disadvantages.

A first aspect is a method for a communication device, wherein the communication device comprises a visual sensor. The method comprises using the visual sensor for detecting another communication device, wherein the other communication device is detected by distinguishing an identifier which is visually arranged on the other communication device. The method also comprises estimating a direction associated with the communication device and the other communication device, and causing subsequent communication between the other communication device and the communication device to be based on the estimated direction.

In some embodiments, causing subsequent communication between the other communication device and the communication device to be based on the estimated direction comprises reducing an amount of potential beams for the communication based on the estimated direction.

In some embodiments, the direction associated with the communication device and the other communication device comprises a direction from the communication device towards the other communication device.

In some embodiments, causing subsequent communication between the other communication device and the communication device to be based on the estimated direction comprises transmitting a report indicative of the distinguished identifier, and/or of spatial information associated with the estimated direction.

In some embodiments, the direction associated with the communication device and the other communication device comprises a direction from the other communication device towards the communication device.

In some embodiments, the other communication device is a serving radio access node for the communication device, and the method further comprises receiving a message indicative of the identifier.

In some embodiments, the message is configured to trigger a beam sweep of the communication device.

In some embodiments, the method further comprises updating the estimated direction based on change in location and/or orientation of the communication device.

In some embodiments, the method further comprises storing the estimated direction as associated with the distinguished identifier and with location and/or orientation of the communication device.

In some embodiments, causing subsequent communication between the other communication device and the communication device to be based on the estimated direction comprises using the stored estimated direction.

In some embodiments, the method further comprises activating the visual sensor for device detection in response to: change in location and/or orientation of the communication device, and/or reception of an identifier indication provided from the other communication device, and/or lack of applicable stored estimated direction.

In some embodiments, the estimated direction associated with the communication device and the other communication device is a primary direction, and the method further comprises using the visual sensor for locating a surface for potential radio reflection of signaling between the other communication device and the communication device, estimating a secondary direction associated with the communication device, the other communication device, and the located surface, and causing subsequent communication between the other communication device and the communication device to be based on the secondary estimated direction.

In some embodiments, the method further comprises using the visual sensor for discovering an object for potential blocking of signaling between the other communication device and the communication device, and transmitting an indication of the discovered object.

In some embodiments, the indication of the discovered object comprises a blocking start time and/or a blocking duration.

A second aspect is a computer program product comprising a non-transitory computer readable medium, having thereon a computer program comprising program instructions. The computer program is loadable into a data processing unit and configured to cause execution of the method according to the first aspect when the computer program is run by the data processing unit.

A third aspect is an apparatus for a communication device, wherein the communication device comprises a visual sensor. The apparatus comprises controlling circuitry configured to cause use of the visual sensor for detection of another communication device, wherein the other communication device is detected by distinguishing of an identifier which is visually arranged on the other communication device. The controlling circuitry is also configured to cause estimation of a direction associated with the communication device and the other communication device, and subsequent communication between the other communication device and the communication device to be based on the estimated direction.

A fourth aspect is a communication device comprising the apparatus of the third aspect and a visual sensor.

In some embodiments, the communication device is one or more of: a user equipment (UE), a pair of virtual reality (VR) glasses, a pair of augmented reality (AR) glasses, a vehicle, a drone, an industrial robot, and a robot for consumer use.

A fifth aspect is a communication device configured for communication with another communication device comprising a visual sensor. The communication device has an identifier which is visually arranged on the communication device, whereby the identifier is configured to be distinguishable by the visual sensor of the other communication device for estimation of a direction associated with the other communication device and the communication device. The communication device is configured to let subsequent communication between the communication device and the other communication device be based on the estimated direction.

In some embodiments, the communication device is configured to receive a report indicative of spatial information associated with the estimated direction.

In some embodiments, the estimated direction associated with the other communication device and the communication device is a primary direction, and the spatial information is further associated with a secondary direction associated with the other communication device, the communication device, and a surface for potential radio reflection of signaling between the communication device and the other communication device.

In some embodiments, the communication device is configured to let subsequent communication between the communication device and the other communication device be based on the estimated direction by reducing an amount of potential beams for the communication based on the spatial information.

In some embodiments, the communication device is further configured to receive a report indicative of a distinguished identifier of a different communication device configured for communication with the other communication device.

In some embodiments, the communication device is configured to perform handover to the different communication device responsive to receiving the report indicative of the distinguished identifier of the different communication device.

In some embodiments, the communication device is configured to transmit a message indicative of the identifier to the other communication device.

In some embodiments, the communication device is configured to receive an indication of an object for potential blocking of signaling between the communication device and the other communication device, and to mitigate the potential blocking by one or more of: pausing transmission, increasing robustness of transmission, performing handover, beam reselection, and triggering a change in location and/or orientation for the other communication device.

In some embodiments, the identifier comprises one or more of: a string of numbers and/or letters, a one-dimensional pattern, a two-dimensional pattern, and a time-dimensional blinking pattern.

In some embodiments, the communication device further comprises illumination of the identifier.

In some embodiments, the communication device is one or more of: a radio access node, an antenna node for a distributed multiple-input multiple-output (MIMO) system, a user equipment (UE), a vehicle, a drone, and an industrial robot.

In some embodiments, any of the above aspects may additionally have features identical with or corresponding to any of the various features as explained above for any of the other aspects.

An advantage of some embodiments is that new approaches to direction-based communication are provided.

An advantage of some embodiments is that overhead signaling and/or delay associated with beam selection may be reduced compared to other approaches.

An advantage of some embodiments is that throughput may be increased compared to other approaches.

An advantage of some embodiments is that latency may be decreased compared to other approaches.

An advantage of some embodiments is that beam tracking may be improved compared to other approaches.

An advantage of some embodiments is that negative effects of blocking events may be mitigated.

### BRIEF DESCRIPTION OF THE DRAWINGS

Further objects, features and advantages will appear from the following detailed description of embodiments, with reference being made to the accompanying drawings. The drawings are not necessarily to scale, emphasis instead being placed upon illustrating the example embodiments.

FIG. 1 is a flowchart illustrating example method steps according to some embodiments;

FIG. 2 is a flowchart illustrating example method steps according to some embodiments;

FIG. 3A is a signaling diagram illustrating example signaling according to some embodiments;

FIG. 3B is a signaling diagram illustrating example signaling according to some embodiments;

FIG. 4 is a collection of schematic drawings illustrating example beam management procedures according to some embodiments;

FIG. 5 is a schematic drawing illustrating example scenarios according to some embodiments;

FIG. 6 is a schematic block diagram illustrating an example apparatus according to some embodiments;

FIG. 7 is a schematic block diagram illustrating an example apparatus according to some embodiments; and

FIG. 8 is a schematic drawing illustrating an example computer readable medium according to some embodiments.

### DETAILED DESCRIPTION

As already mentioned above, it should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

In the following, new approaches to direction-based communication will be exemplified with reference to various embodiments, wherein a first communication device and a second communication device are configured for communication with each other.

The first communication device comprises a visual sensor (e.g., a camera), and an identifier is visually arranged on the second communication device. The visual sensor can be used for detecting the second communication device by distinguishing the identifier.

Generally, it should be noted that a distinguished identifier typically represents that there is a line-of-sight (LoS) path between the communication device with the visual sensor and the communication device which has the identifier.

Also generally, the identifier may be any suitable identifier. For example, the identifier may comprise one or more of: a string of numbers and/or letters, a one-dimensional pattern (e.g., an EAN-code), a two-dimensional pattern (e.g., a QR-code), and a time-dimensional blinking pattern.

Responsive to detection of the second communication device, the first communication device can estimate a direction associated with the first and second communication devices (e.g., a direction from the first communication device towards the second communication device, and/or a direction from the second communication device towards the first communication device).

The estimated direction can be used for subsequent communication between the first and second communication devices. For example, the estimated direction may be used (by the first and/or second communication device) for selection of transmission and/or reception beams. In some embodiments, a particular beam or antenna panel is selected based on (e.g., corresponding to) the estimated direction. In some embodiments, an amount of potential beams considered for a beam selection process is reduced (i.e., the search space for beam selection is reduced) based on the estimated direction (e.g., removing beams that are not close to the estimated direction, and/or removing antenna panels that are not in correspondence with the estimated direction). These approaches may all be considered as reducing an amount of potential beams.

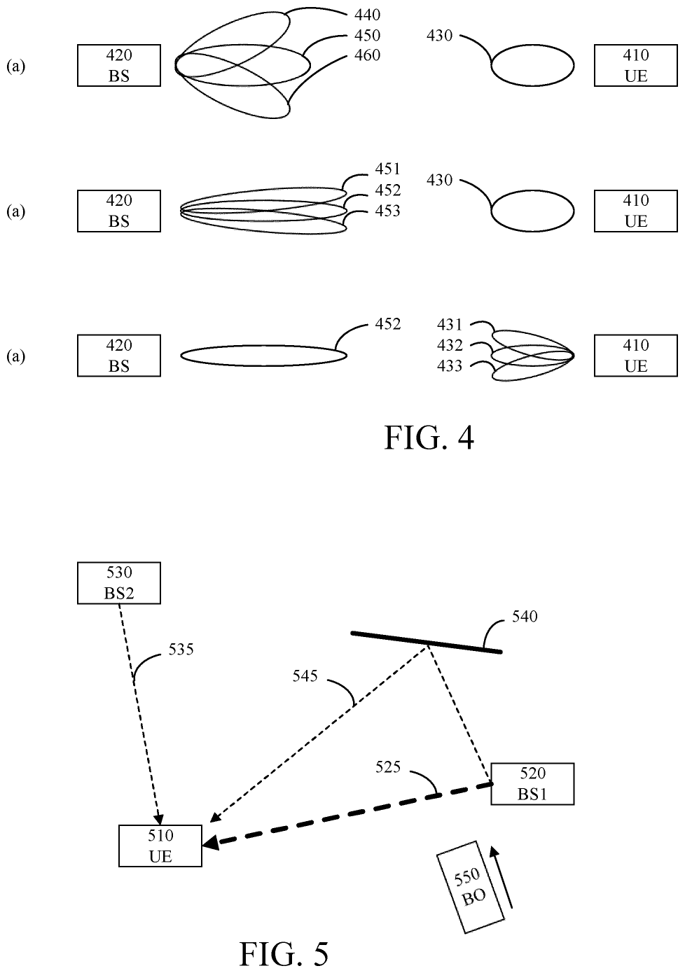

To illustrate the advantages of reducing the amount of potential beams, the following example may be considered. A UE configured to operate at mmWave frequencies typically comprises multiple antenna panels, where the UE can activate one of the antenna panels at each time instance. When each antenna panel is configured to provide multiple beams, there are a large number of beams to scan in a beam selection process. For example, when there are 4antenna panels and each antenna panel is configured to provide 15 beams, 60 candidate beams (i.e., potential beams) need to be scanned. When SSB is used for reception beam selection (as will be elaborated on in connection with FIG. 4) and three beams can be evaluated per SSB, the UE needs to receive 20 SSB bursts to evaluate all candidate beams. When SSB is transmitted every 20 ms, it may take 400 ms for the UE to find a suitable reception beam. The delay caused by such beam selection processing may be problematic. For example, the delay may cause reduced performance when the UE is moving (e.g., changing location and/or orientation). Thus, reducing the amount of potential beams that need to be processed can be very advantageous.

Generally, the first and second communication devices (and the third communication device as will be mentioned below) may be any suitable communication devices.

For example, the first communication device may be a user equipment (UE), a pair of virtual reality (VR) glasses, a pair of augmented reality (AR) glasses, a vehicle, a drone, an industrial robot, or a robot for consumer use.

The second communication device may be a serving radio access node, a non-serving radio access node, an antenna node for a distributed multiple-input multiple-output (MIMO) system, a UE, a vehicle, a drone, or an industrial robot, for example.

The third communication device may be a serving radio access node, an antenna node for a distributed multiple-input multiple-output (MIMO) system, a UE, a vehicle, a drone, or an industrial robot, for example.

In the description herein, the first communication device will mostly exemplified as a UE or a pair of VR/AR glasses, and the second and third communication devices will mostly exemplified as radio access nodes (e.g., base stations, gNodeBs, IEEE 802.11 access points, etc.).

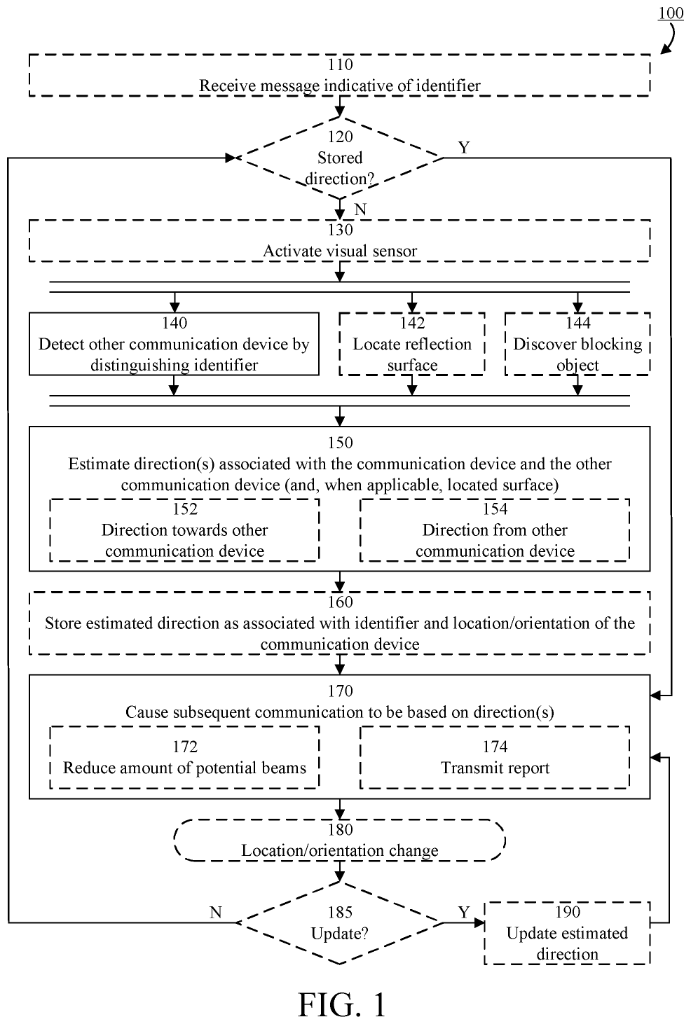

FIG. 1 illustrates an example method 100 according to some embodiments. The method 100 is for performance by a first communication device, which comprises a visual sensor.

In step 140, the visual sensor is used for detecting another (second) communication device by distinguishing an identifier which is visually arranged on the other communication device.

In some embodiments, a message indicative of the identifier is received from the second communication node. The message may be received prior to using the visual sensor for detecting the second communication device, as illustrated by optional step 110. One example might be when the second communication node is a serving radio access node for the first communication device and the message is received in association with connection setup with the second communication node and/or in association with handover to the second communication node.

Generally, when the term “handover” is used herein, it may refer to a switch from a first radio access node to a second radio access node, where the first and second radio access nodes are associated with different physical cell identities (PCIs) or where the first and second radio access nodes are associated with the same physical cell identity (PCI). Thus, the term “handover” can refer to a switch between radio access nodes providing different serving cells (i.e., switch of serving cell) or to a switch between radio access nodes providing the same serving cell.

Receiving a message indicative of the identifier may be advantageous since the first communication device may look particularly for that identifier, and/or since-when an identifier is distinguished-the first communication device knows whether it has detected the serving radio access node or a communication device which is not the serving radio access node.

The message may be received via any suitable control signaling. For example, the message may be received via radio resource control (RRC), medium access control (MAC) control element (MAC-CE), downlink control information (DCI), or similar.

In some embodiments, the message is configured to trigger a beam sweep of the first communication device. When a beam sweep is triggered by the message, the beam sweep may benefit from the detection of step 140 as will be exemplified in the following.

It should be noted that, generally, a message indicative of the identifier and/or configured to trigger a beam sweep may—alternatively or additionally—be received after using the visual sensor for detecting the second communication device.

In step 150, a direction is estimated, which is associated with the first communication device and the second communication device. The direction may comprise a direction from the first communication device towards the second communication device, as illustrated by optional substep 152. Alternatively or additionally, the direction may comprise a direction from the second communication device towards the first communication device, as illustrated by optional substep 154.

In step 170, subsequent communication between the second communication device and the first communication device is caused to be based on the estimated direction.

Step 170 may comprise reducing an amount of potential beams based on the estimated direction, as illustrated by optional substep 172. Substep 172 is typically applied together with substep 152.

Reducing the amount of potential beams based on the estimated direction may be seen as applying a spatial filter to the potential beams, wherein the spatial filter passes beam(s) that correspond to, and/or are close to, the estimated direction and blocks other beams.

In some embodiments, substep 172 may comprise selecting a transmission beam and/or a reception beam, to be used by the first communication device in the subsequent communication, based on (e.g., corresponding to) the estimated direction. Alternatively or additionally, substep 172 may comprise selecting an antenna panel, to be used by the first communication device in the subsequent communication, based on (e.g., corresponding to) the estimated direction. Yet alternatively or additionally, substep 172 may comprise removing, based on the estimated direction, one or more beams (e.g., beams that are not close to the estimated direction) from consideration in a process for selection of transmission beam and/or reception beam to be used by the first communication device in the subsequent communication. In some embodiments, removing one or more beams for consideration is implemented by removing one or more antenna panels from consideration.

Alternatively or additionally to reducing an amount of potential beams based on the estimated direction, step 170 may comprise transmitting a report by the first communication device, as illustrated by optional substep 174. Substep 174 is typically applied together with substep 154.

The report may be transmitted using any suitable control signaling. For example, the report may be transmitted using medium access control (MAC) control element (MAC-CE), uplink control information (UCI), a signal transmitted on dedicated UL resources, or similar.

The report is indicative of the distinguished identifier, and/or spatial information associated with the estimated direction (e.g., the estimated direction and/or a corresponding spatial filter).

The report is typically intended for the second communication device, or for yet another (third) communication device. For example, when the first communication device detects a second communication device that is not a serving radio access node for the first communication device, the report may be intended for a third communication device that is the serving radio access node for the first communication device.

When the report is intended for the second communication device, it is typically indicative of at least the spatial information.

When the report is received by the second communication device, the spatial information can be used by the second communication device for subsequent communication between the second communication device and the first communication device. For example, the second communication device may reduce an amount of potential beams based on the spatial information (similarly to optional substep 172).

When the report is not intended for the second communication device, but for a third communication device, it is typically indicative of at least the distinguished identifier.

When the report is received by the third communication device, the spatial information can be used by the third communication device for subsequent communication between the second and/or third communication device and the first communication device. For example, the third communication device may perform a handover to the second communication device in response to the report (possibly also informing the second communication device of the spatial information for use by the second communication device as mentioned above). Alternatively or additionally, the third communication device may cause the second communication device to be used for enhanced transmission (possibly also informing the second communication device of the spatial information for use by the second communication device as mentioned above). In some embodiments, enhanced transmission comprises redundancy transmission (e.g., duplicating data transmissions from the third communication device). In some embodiments, enhanced transmission comprises additional content transmission (e.g., transmitting an additional multiple-input multiple-output, MIMO, stream from the second communication device).

When the estimated direction is used to reduce the amount of potential beams (at either communication device), the overhead signaling and/or delay associated with beam selection may be reduced compared to other approaches, which may—in turn—increase throughput and/or reduce latency.

When the report leads to handover or enhanced transmission, the throughput may be increased.

In some embodiments, the method 100 further comprises storing the estimated direction as associated with the distinguished identifier and with location and/or orientation of the first communication device. This is illustrated by optional step 160. Thereby, a database may be built and/or updated, wherein the database indicates which direction to use for communication based on the location and/or orientation of the first communication device.

Generally, entries of a database that indicates which direction to use for communication based on the location and/or orientation of the first communication device may be pre-loaded to the first communication device (e.g., for a virtual reality application executed in a specific physical space with known access points), and/or may be created/updated by the first communication device as exemplified by step 160.

In either case, step 170 may be based on a direction estimated in step 150 and/or on a stored direction retrieved from the database. This is exemplified in FIG. 1 by optional step 120, in which it is determined whether there is a stored direction for the current location and/or orientation of the first communication device. When there is a stored direction for the current location and/or orientation of the first communication device (Y-path out of step 120), that direction can be used directly in step 170. When there is not a stored direction for the current location and/or orientation of the first communication device (N-path out of step 120), the visual sensor is used as explained above. It should be noted that the visual sensor may be used as explained above even when there is a stored direction for the current location and/or orientation of the first communication device according to some embodiments (e.g., to check, update, replace, or refine the stored direction).

Embodiments that apply a database as exemplified above may provide the advantage that steps 140 and 150 need not be performed repeatedly for the same location and/or orientation of the first communication device, which may, for example, reduce power consumption at the first communication device.

When the location and/or orientation of the first communication device changes, as illustrated by optional step 180, it may be determined whether or not an update of the estimated direction should be performed, as illustrated by optional step 185.

If an update of the estimated direction should not be performed (N-path out of step 185), the method may return to step 120 for acquisition of a new estimated direction.

If an update of the estimated direction should be performed (Y-path out of step 185), the estimated direction is updated in optional step 190 and the method returns to step 170 (or to step 160). To exemplify when this option might be relevant, it may be possible to track the change of the estimated direction (i.e., without using the visual sensor for a new detection and/or without performing a full beam sweep) when the change in location and/or orientation of the first communication device is relatively small and/or relatively slow.

A change in orientation of the first communication device may be associated with a corresponding angular change of the direction from the first communication device towards the second communication device (and no change in the direction from the second communication device towards the first communication device; i.e., no report need to be transmitted for this case).

A change in location of the first communication device may be associated with an angular change of the direction from the first communication device towards the second communication device, as well as an angular change in the direction from the second communication device towards the first communication device; both of which may be estimated, for example, using trigonometry and an assumption regarding the distance between the first and second communication devices.

Embodiments that apply updating of the estimated direction when the location and/or orientation of the first communication device changes (as exemplified by steps 180, 185 and 190) may provide the advantage that steps 140 and 150 need not be performed repeatedly for minor changes of location and/or orientation of the first communication device, which may, for example, reduce power consumption at the first communication device. Alternatively or additionally, beam tracking may be improved.

In some embodiments, the visual sensor is only activated for device detection in response to one or more triggering events, as illustrated by optional step 130. Selective activation of the visual sensor may reduce power consumption at the first communication device.

For example, the visual sensor may be activated for device detection in response to a change (e.g., an expected change or an actual change) in location and/or orientation of the communication device (step 180); possibly after determining that an update of the estimated direction should not be performed (N-path out of step 185).

Alternatively or additionally, the visual sensor may be activated for device detection in response to reception of an identifier indication provided from the second communication device (step 110).

Alternatively or additionally, the visual sensor may be activated for device detection in response to lack of applicable stored estimated direction (N-path out of step 120).

The visual sensor may further be used for locating a surface for potential radio reflection of signaling between the second communication device and the first communication device, as illustrated by optional step 142. Step 142 may be performed in parallel to step 140 as illustrated in FIG. 1, or steps 140 and 142 may be performed in sequence.

When a surface is located, step 150 may further comprise estimating a direction associated with the first communication device, the second communication device, and the located surface (e.g., a direction from the first communication device towards the located surface, and/or a direction from the second communication device towards the located surface).

The direction associated with the first communication device and the second communication device may be seen as a primary direction (e.g., a line-of-sight direction), and the direction associated with the first communication device, the second communication device and the located surface may be seen as a secondary direction.

Either or both of the primary and the secondary directions may be used in step 170. For example, the second communication device may use the secondary direction when the primary direction is blocked. Alternatively or additionally, the second communication device may use the secondary direction for enhancing transmission based on the primary direction (e.g., transmitting the same data on two beams based on the primary direction and the secondary direction, or using the secondary direction for transmission of an additional MIMO).

Embodiments that apply location of surface(s) for potential radio reflection may have advantages such as improved robustness and/or increased throughput.

The visual sensor may further be used for discovering an object for potential blocking of signaling between the second communication device and the first communication device, as illustrated by optional step 144. Step 144 may be performed in parallel to step 140 (and/or in parallel to step 142) as illustrated in FIG. 1, or steps 140 (and/or step 142) and 144 may be performed in sequence.

When an object for potential blocking is discovered, an indication of the discovered object may be transmitted to the second communication device (or to a third communication device, in similarity to the earlier exemplification). For example, the indication of the discovered object may comprise one or more of: an estimated time for start of the blocking event (i.e., a blocking start time), an estimated duration of the blocking event (i.e., a blocking duration), and an estimated time for end of the blocking event (i.e., a blocking end time).

The indication of the discovered object may be transmitted using any suitable control signaling. For example, the indication of the discovered object may be transmitted using medium access control (MAC) control element (MAC-CE), uplink control information (UCI), a signal transmitted on dedicated UL resources, or similar.

For example, the indication may be transmitted in step 170 (e.g., together with-or instead of-the report of step 174).

The communication device that receives the indication of the discovered object (i.e., the second or third communication device) can take one or more measures to mitigate the potential blocking.

For example, transmission may be paused during the blocking event, or the robustness of transmission may be increased during the blocking event (e.g., by changing modulation and coding scheme, MCS; and/or adding redundancy transmission).

Alternatively or additionally, handover to a different communication device may be performed (e.g., to a communication device whose identifier was indicated as distinguished in the report of step 174).

Yet alternatively or additionally, beam reselection may be performed (e.g., to select a beam associated with a located surface for potential radio reflection).

Yet alternatively or additionally, a trigger may be transmitted to provoke a change in location and/or orientation for the first communication device (to avoid the blocking event). This approach may be particularly applicable when the first communication device is a vehicle, a drone, or a robot.

Embodiments that apply discovery of object(s) for potential blocking may have advantages such as improved robustness. Thus, negative effects of blocking events may be mitigated.

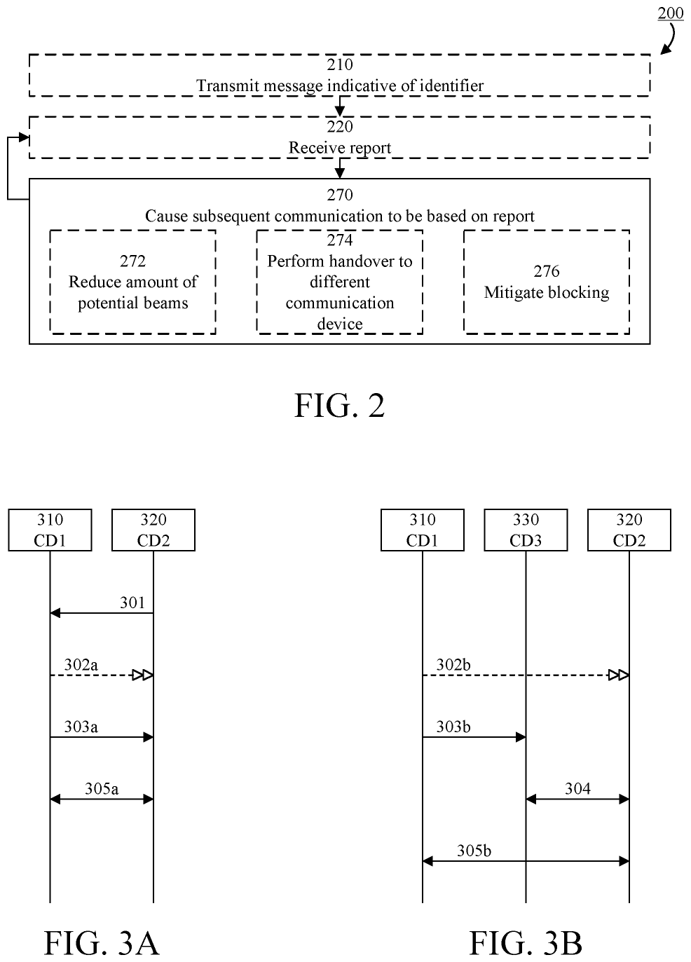

FIG. 2 illustrates an example method 200 according to some embodiments. The method 200 is for performance by a second or third communication device, configured for communication with a first communication device comprising a visual sensor (e.g., the first communication device performing the method 100 of FIG. 1).

When the method 200 is performed by the second communication device, it has an identifier which is visually arranged on the communication device, whereby the identifier is configured to be distinguishable by the visual sensor of the first communication device for estimation of a direction associated with the second communication device and the first communication device.

When the method is performed by the third communication device, a different (the second) communication device has an identifier which is visually arranged on the communication device, whereby the identifier is configured to be distinguishable by the visual sensor of the first communication device for estimation of a direction associated with the second communication device and the first communication device. In this case, the third communication device may, or may not, have an identifier visually arranged on the communication device.

As illustrated by optional step 210, the method 200 may comprise (particularly for the case when the method 200 is performed by the second communication device) transmitting a message indicative of the identifier of the second communication device to the first communication device (compare with step 110 of FIG. 1).

Regardless of whether the method 200 is performed by the second or third communication device, the method 200 may comprise receiving a report from the first communication device, as illustrated by optional step 220 (compare with step 174 of FIG. 1). When the method 200 is performed by the second communication device, the report is at least indicative of spatial information associated with a direction estimated by the first communication device (compare with step 150 of FIG. 1). When the method 200 is performed by the third communication device, the report is at least indicative of the identifier of the second communication device as distinguished by the first communication device.

As illustrated by step 270, the method 200 comprises causing subsequent communication between the second or third communication device and the first communication device to be based on the report.

For example, step 270 may comprise reducing an amount of potential beams for the second or third communication device based on the spatial information, as illustrated by optional substep 272. This can be equally applicable when the method 200 is performed by the second communication device or by the third communication device. Various ways of reducing an amount of potential beams have already been described in connection with FIG. 1 and are not repeated for FIG. 2.

Alternatively or additionally, when the method 200 is performed by the third communication device, step 270 may comprise performing handover to the second communication device, as illustrated by optional substep 274, and/or using the second communication device for enhanced transmission. In these embodiments, the third communication device may also inform the second communication device of spatial information indicated by the report (e.g., to be used for reducing an amount of potential beams for the second communication device as described above).

Yet alternatively or additionally, when the method 200 is performed by the second communication device, the report may be indicative of an indication of an object for potential blocking of signaling between the second communication device and the first communication device. Then, step 270 may comprise mitigating the potential blocking, as illustrated by optional substep 276. Various ways of mitigating the effects of blocking have already been described in connection with FIG. 1 and are not repeated for FIG. 2.

FIG. 3A illustrates example signaling between a first communication device 310 (CD1; e.g., performing the method 100 of FIG. 1) and a second communication device 320 (CD2; e.g., performing the method 200 of FIG. 2).

The example signaling starts by CD2 transmitting a message 301 to CD1, wherein the report is indicative of the identifier of CD2 (compare with step 210 of FIG. 2 and step 110 of FIG. 1).

As illustrated by 302a, CD1 uses the visual sensor to detect CD2 by distinguishing the identifier as arranged on CD2 (compare with step 140 of FIG. 1).

The example signaling continues by CD1 transmitting a report 303a to CD2, which is indicative of spatial information associated with a direction between CD2 and CD1 as estimated by CD1 (compare with step 174 of FIG. 1 and step 220 of FIG. 2).

As illustrated by 305a, subsequent communication between CD1 and CD2 is based on the spatial information indicated in the report (compare with step 272 of FIG. 2).

FIG. 3B illustrates example signaling between a first communication device 310 (CD1; e.g., performing the method 100 of FIG. 1), a second communication device 320 (CD2), and a third communication device 330 (CD3; e.g., performing the method 200 of FIG. 2).

As illustrated by 302b, CD1 uses the visual sensor to detect CD2 by distinguishing an identifier arranged on CD2 (compare with step 140 of FIG. 1).

The example signaling continues by CD1 transmitting a report 303b to CD3, wherein the report is indicative of the identifier of CD2 as distinguished by CD1 (compare with step 174 of FIG. 1 and step 220 of FIG. 2).

As illustrated by 304, CD3 performs a handover to CD2 responsive to receiving the report 303b (compare with step 274 of FIG. 2), and subsequent communication between CD1 and CD2 is illustrated by 305b.

Beam-formed communication schemes utilizing narrow beams for transmission and reception are typically applied for relatively high frequencies to compensate for the relatively high propagation loss experienced for the relatively high frequencies.

In a common approach for downlink transmission, it is expected that the network selects and maintains, for each UE, a suitable transmission beam from the radio access node, and that each UE selects and maintains a suitable reception beam. This is typically achieved via measurements on downlink reference signals (e.g., channel state information reference signals, CSI-RS, and/or synchronization signal block, SSB).

In relation to new radio (NR) as currently specified by 3GPP, the SSB is a broadcast signal that may be useful, for example, for providing initial synchronization, basic system information for initial access, and mobility measurements. The NR SSB comprises a Primary Synchronization Signal (PSS), a Secondary Synchronization Signal (SSS), and a Physical Broadcast CHannel (PBCH).

Different PSS sequences can be used; derived from different cyclic shifts of a basic sequence. When a PSS is detected, the transmission timing of the SSS is known. There are many different SSS sequences; derived from different shifts of one or more basic sequences. The combination of PSS and SSS determines the physical cell identity (PCI) of the cell. In NR, there are 336 different SSSs and 3 different PSSs, which enables 1008 different PCIs.

For relatively low frequencies, it is expected that each cell transmits one SSB that covers the whole cell. For relatively higher frequencies, it is expected that several beam-formed SSBs are needed to enable coverage for the whole cell.

There is typically a maximum number of SSBs per cell (e.g., 4 SSBs for frequencies below 3 GHz, 8 SSBs for frequencies between 3 GHZ and 6 GHZ, AND 64 for frequencies above 6 GHz). The SSBs may be transmitted in an SSB transmission burst, which could last, for example, up to 5 ms. A periodicity of the SSB burst may be configurable with the following options: 5, 10, 20, 40, 80, or 160 ms.

For example, beam selection and maintenance for downlink transmission may comprise the radio access node transmitting CSI-RS/SSB using different transmission beams, the UE performing reference signal received power (RSRP) measurements for the different transmission beams, and the UE reporting the N (e.g., a network configurable parameter) best transmission beams along with their respective RSRP values to the radio access node.

The CSI-RS for beam management can be transmitted periodically, semi-persistently, or aperiodically. Furthermore, CSI-RS can be shared between multiple UEs, or be UE-specific. The SSB is typically transmitted periodically, and shared between all UEs.

Although not explicitly stated in the specification documents of the third generation partnership project (3GPP), beam management may be divided in to three procedures (P-1, P-2, P-3), which are schematically illustrated in FIG. 4 for a base station (BS) 420 and a UE 410.

The procedure P-1 is illustrated in part (a) of FIG. 4. The purpose of P-1 is to find a coarse direction from the BS towards the UE, and relatively wide transmission beams 440, 450, 460 (e.g., covering a whole angular sector) are used by the BS while a single wide (or omnidirectional) reception beam 430 is used by the UE. The reference signals may be transmitted periodically (e.g., using periodic CSI-RS or SSB) and may be shared between all UEs of a cell.

By the end of the procedure P-1, the UE reports the N best transmission beams and their respective RSRP values to the BS.

The procedure P-2 is illustrated in part (b) of FIG. 4. The purpose of P-2 is to refine the BS transmission beam, which may be achieved by performing a new beam search with relatively narrow transmission beams 451, 452, 453 around the coarse direction 450 found in P-1, while a single wide (or omnidirectional) reception beam 430 is used by the UE. The reference signals may be transmitted non-periodically (e.g., using aperiodic or semi-persistent CSI-RS). By the end of the procedure P-2, the UE reports best transmission beams and their respective RSRP values to the BS.

The procedure P-3 is illustrated in part (c) of FIG. 4. The purpose of P-3 is to find a reception beam for the UE (e.g., when the UE has analog beamforming), which may be achieved by reference signal transmission on the relatively narrow transmission beam 452 found in P-2, while different reception beams 431, 432, 433 are used by the UE. The reference signals may be transmitted non-periodically (e.g., using aperiodic or semi-persistent CSI-RS), or the UE may use the SSB transmissions to evaluate different reception beams. When the UE evaluates different reception beams during periodic SSB transmissions, there may be a maximum of four reception beams evaluated during each SSB burst transmission when each SSB consists of four orthogonal frequency division multiplexing (OFDM) symbols. One advantage of using SSB instead of CSI-RS is that no extra overhead is needed for SSB, while CSI-RS transmission entails extra overhead signaling. By the end of the procedure P-3, the UE selects the best reception beam based on RSRP values. Typically, P-3 is performed relatively often to accommodate, e.g., blocking and/or UE mobility.

It should be noted that embodiments as exemplified herein may be equally applicable in either of P-1, P-2, P-3, and that embodiments may be applied for one or more of the procedures P-1, P-2, P-3. Thus, the UE 410 may be configured to perform one or more steps of the method 100 of FIG. 1 and/or the BS 420 may be configured to perform one or more steps of the method 200 of FIG. 2.

FIG. 5 schematically illustrates various example scenarios according to some embodiments.

For the examples scenarios, a first communication device is represented by a UE 510. The UE 510 may be configured to perform one or more steps of the method 100 of FIG. 1. Particularly, the UE 510 is configured to use a visual sensor to detect a second communication device by distinguishing an identifier of the second communication device.

In some scenarios, the second communication device is represented by a first base station BS1 520. The BS1 520 may be configured to perform one or more steps of the method 200 of FIG. 2 in these scenarios. As already elaborated on, the communication between the second communication device 520 and the first communication device 510 is based on a direction between the devices as estimated by the first communication device 510 responsive to detection of the second communication device 520 by distinguishing its identifier. The communication between the second communication device and the first communication device may use a direct path 525, or may use a path 545 reflected by a surface 540. The first communication device 510 may further use the visual sensor to discover objects for potential blocking; represented in FIG. 5 by blocking object (BO) 550.

In other scenarios, the second communication device is represented by a second base station BS2 530, and the first base station BS1 520 represents a third communication device. The BS1 520 may be configured to perform one or more steps of the method 200 of FIG. 2 in these scenarios. As already elaborated on, the first communication device 510 may detect the second communication device 530 by distinguishing its identifier, and report the distinguished identifier to the third communication device 520, which may perform handover to the second communication device 530. The subsequent communication between the second communication device 530 and the first communication device 510 may use a direct path 535, for example.

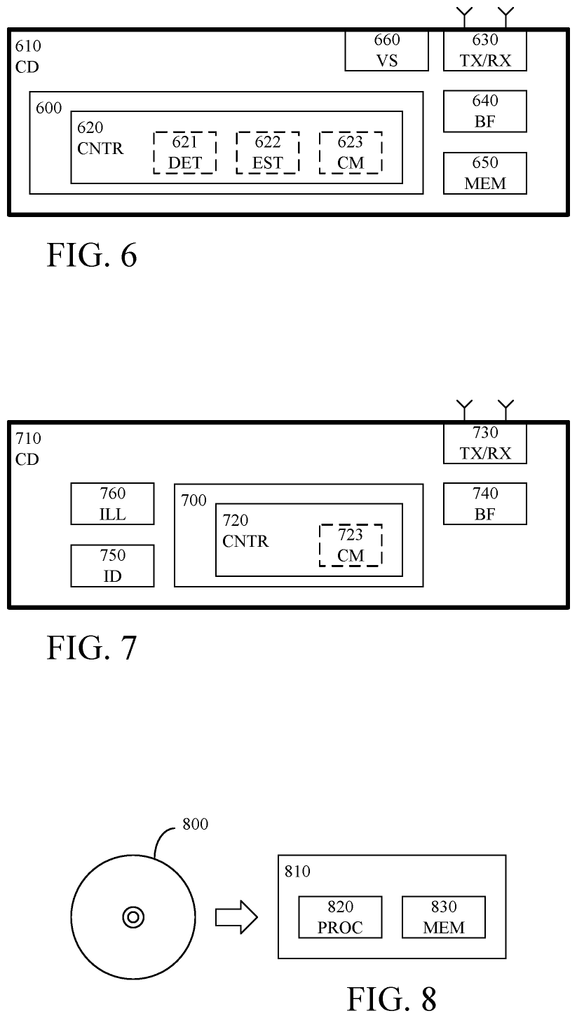

FIG. 6 schematically illustrates an example apparatus 600 according to some embodiments. The apparatus 600 may be comprisable (e.g., comprised) in a communication device (CD; e.g., a first communication device), which comprises a visual sensor (VS) 660. Alternatively or additionally, the apparatus 600 may be configured to cause execution of (e.g., execute) one or more steps of the method 100 in FIG. 1.

The apparatus 600 comprises a controller (CNTR; e.g., controlling circuitry or a control module) 620.

The controller 620 is configured to cause use of the visual sensor for detection of another (second) communication device, wherein the second communication device is detected by distinguishing of an identifier which is visually arranged on the second communication device (compare with step 140 of FIG. 1).

To this end, the controller may comprise or be otherwise associated with (e.g., connected, or connectable, to) a detector (DET; e.g., detecting circuitry or a detection module) 621. The detector 621 may be configured to detect the second communication device by distinguishing the identifier using the visual sensor 660.

The controller 620 is also configured to cause estimation of a direction associated with the first communication device and the second communication device (compare with step 150 of FIG. 1).

To this end, the controller may comprise or be otherwise associated with (e.g., connected, or connectable, to) an estimator (EST; e.g., estimating circuitry or an estimation module) 622. The estimator 622 may be configured to estimate the direction associated with the first communication device and the second communication device.

The controller 620 is also configured to cause subsequent communication between the second communication device and the first communication device to be based on the estimated direction (compare with step 170 of FIG. 1).

To this end, the controller 620 may comprise or be otherwise associated with (e.g., connected, or connectable, to) a communication manager (CM; e.g., managing circuitry or a management module) 623. The communication manager 623 may be configured to control subsequent communication between the second communication device and the first communication device based on the estimated direction.

For example, the controller 620 may be configured to cause the subsequent communication to be based on the estimated direction by causing reduction of an amount of potential beams for the communication based on the estimated direction (compare with step 172 of FIG. 1), e.g., by controlling a beam-former (BF; e.g., beam-forming circuitry or a beam-form module) 640 of the first communication device 610.

Alternatively or additionally, the controller 620 may be configured to cause the subsequent communication to be based on the estimated direction by causing transmission of a report (compare with step 174 of FIG. 1), e.g., via a transceiver (TX/RX; e.g., transceiving circuitry or a transceiver module) 630 of the first communication device 610.

In some embodiments, the controller 620 is configured to cause reception of a message indicative of the identifier (compare with step 110 of FIG. 1), e.g., via the transceiver 630 of the first communication device 610.

In some embodiments, the controller 620 is configured to cause storing of the estimated direction as associated with the distinguished identifier and with location and/or orientation of the communication device (compare with step 160 of FIG. 1), e.g., in a memory (MEM) 650 of the first communication device.

FIG. 7 schematically illustrates an example apparatus 700 according to some embodiments. The apparatus 700 may be comprisable (e.g., comprised) in a communication device (CD; e.g., a second or third communication device) 710. Alternatively or additionally, the apparatus 700 may be configured to cause execution of (e.g., execute) one or more steps of the method 200 in FIG. 2.

The communication device 710 has an identifier (ID) 750, which is visually arranged on the communication device, whereby the identifier is configured to be distinguishable by a visual sensor of another communication device. In some embodiments, the communication device also comprises illumination (ILL) 760 of the identifier. The illumination may be any suitable illumination. For example, the illumination may comprise one or more of: a lamp directed on a surface where the identifier is arranged, backlighting of the identifier when the identifier and/or a surface where the identifier is arranged is transparent, and luminescence of the identifier itself (e.g., implemented by fluorescence, diodes, or similar).

The apparatus 700 comprises a controller (CNTR; e.g., controlling circuitry or a control module) 720.

The controller 720 is configured to cause reception of a report (compare with step 220 of FIG. 2), e.g., via a transceiver (TX/RX; e.g., transceiving circuitry or a transceiver module) 730 of the communication device 710.

The controller 720 is also configured to cause subsequent communication to be based on the report (compare with step 270 of FIG. 2).

To this end, the controller 720 may comprise or be otherwise associated with (e.g., connected, or connectable, to) a communication manager (CM; e.g., managing circuitry or a management module) 723. The communication manager 723 may be configured to control subsequent communication based on the report.

For example, the controller 720 may be configured to cause subsequent communication to be based on the report by causing reduction of an amount of potential beams for the communication based on spatial information indicated by the report (compare with step 272 of FIG. 2), e.g., by controlling a beam-former (BF; e.g., beam-forming circuitry or a beam-form module) 740 of the communication device 710.

In some embodiments, the controller 720 is configured to cause transmission of a message indicative of the identifier (compare with step 210 of FIG. 2), e.g., via the transceiver 730 of the communication device 710.

It should be noted that, generally, the communication device 710 may comprise both the apparatus 700 and the identifier 750 (e.g., when the communication device 710 is a second communication device configured to perform the method 200 of FIG. 2), or may comprise the apparatus 700 but not necessarily the identifier 750 (e.g., when the communication device 710 is a third communication device configured to perform the method 200 of FIG. 2), or may comprise the identifier 750 but not necessarily the apparatus 700 (e.g., when the communication device 710 is a second communication device, and a third communication device is configured to perform the method 200 of FIG. 2).

Generally, it should be noted that features and advantages described herein in connection with any one or more of the Figures, may be equally applicable (mutatis mutandis) in relation to any other one or more of the Figures; even if not explicitly mentioned in connection thereto.

Some particular examples will now be described, which may be relevant in relation to some embodiments. The particular examples related to beam management assisted by VR/AR glasses.

When reference is made to “specification”, the reference may entail the specification documents of a standardization body such as the third generation partnership project (3GPP), product specification, or any other suitable specification.

It is a problem in current NR networks that beam management procedures are slow, which deteriorates the performance for moving UEs. One contributing factor to this problem is that the time it takes for the UE to find a suitable reception beam is relatively long. Furthermore, the reception beam selection must be updated relatively often when the UE is moving to maintain an adequate link budget between the radio access node and the UE. The same problem is expected for VR/AR glasses.

Some embodiments address this problem by introducing a visual identification number (or other visual identification) for the radio access node. When the UE/glasses have a visual sensor, it can detect the radio access node by distinguishing the visual identification number (compare with step 140 of FIG. 1), estimate a direction towards the radio access node (compare with step 152 of FIG. 1), and use the estimated direction to simplify beam selection (compare with step 172 of FIG. 1). In some embodiments, specification support is also introduced for signaling the identification number to the UE/glasses (compare with step 110 of FIG. 1 and step 210 of FIG. 2).

Thereby, delays caused by beam selection can be reduced, which may entail improved user experience and/or improved network performance, for example.

For example, an identification number for radio access nodes may be introduced in the specification, and the identification number may be used in combination with the camera function of VR/AR glasses to facilitate beam management procedures for VR/AR glasses. The identification number can, for example, be visually printed on the radio access node such that the camera of the VR/AR glasses can detect it.

In some embodiments, new signaling (e.g., conveyed using one or more of RRC, MAC-CE, and DCI) may be introduced in the specification to enable the network to send an indication regarding the identification number of the currently serving radio access node (compare with step 110 of FIG. 1 and step 210 of FIG. 2). Thereby, the VR/AR glasses can use the camera to estimate a direction towards the serving radio access node, and use the estimated direction to improve (e.g., speed up) panel/beam selection at the VR/AR glasses.

In some embodiments, the VR/AR glasses determines a suitable panel and/or a suitable beam directly based on the estimated direction towards the serving radio access node, or uses the estimated direction to reduce the panel/beam search space (compare with step 172 of FIG. 1). Furthermore, when the orientation of the VR/AR glasses changes dynamically (e.g., if the user turns their head in different directions), the VR/AR glasses can estimate a corresponding change in direction and use the estimated change to update the panel and/or beam selection (compare with steps 180, 185, 190 of FIG. 1).

In some embodiments, new signaling (e.g., conveyed using one or more of MAC-CE, and UCI) is introduced in the specification to enable the VR/AR glasses to send an indication of an identification number which has been distinguished (compare with step 174 of FIG. 1 and step 220 of FIG. 2). For example, such an indication may be considered as a request for handover to the radio access node that corresponds to the indicated identification number. Alternatively or additionally, the radio access node that corresponds to the indicated identification number may be used for enabling an additional MIMO stream, or to improve coverage/diversity.

In some embodiments, reduced energy (or power) consumption may be achieved by activating the camera for identification number detection purposes only when the VR/AR glasses have moved (or are expected to move) and/or when the network has signaled an identification number (compare with step 130 of FIG. 1). Accelerometers and/or information about the program (e.g., a game) that is running on the VR/AR glasses may be used to determined when the VR/AR glasses have moved (or are expected to move).

In some embodiments, the VR/AR glasses stores (e.g., in a look-up table) relevant information about radio access nodes that it has detected using the camera (compare with step 160 of FIG. 1). For example, the VR/AR glasses can store information regarding the distinguished identifier of the radio access node, an estimated location of the radio access node, the estimated direction towards the radio access node, the location and/or orientation of the VR/AR glasses when the visual sensor captured the identifier, etc. When a beam/panel switch is necessary for the VR/AR glasses (e.g., due to reception from the network of a new identification number), the VR/AR glasses can first check the look-up table and use any suitable information therein before activating the camera (compare with step 120 of FIG. 1). This approach may lead to reduced energy (or power) consumption, and/or may enable rapid switching between serving radio access nodes.

In some embodiments, the VR/AR glasses informs the network about the estimated direction, and radio access nodes of the network may use the estimated direction for direct selection of panel/beam, or to reduce the panel/beam search space (compare with step 174 of FIG. 1 and step 272 of FIG. 2).

In some embodiments, a beam sweep by the VR/AR glasses is automatically triggered in the same control message that the network uses to indicate the identifier (e.g., in connection with handover). Thereby, the beam sweep by the VR/AR glasses can be performed based on a direction estimated based on visually distinguishing the identifier.

In some embodiments, the camera of the VR/AR glasses is used to determine a suitable non-LoS component for communication with a radio access node. For example, when a pair of VR/AR glasses is communicating with a radio access node under LoS conditions, and the LoS component is suddenly blocked (e.g., due to the VR/AR glasses moving behind a corner), the VR/AR glasses could benefit from knowledge regarding a possible radio reflection that can be used instead of the LoS component. For example, the VR/AR glasses can be configured to recognize (e.g., using suitable image processing) a surface where radio reflection might occur, and prioritize VR/AR glasses panel(s)/beam(s) that are directed towards that surface. In some embodiments, the non-LoS component may be used for enabling an additional MIMO stream, or to provide a back-up link for a potential blocking event.

In some embodiments, the camera of the VR/AR glasses is used to handle potential blocking objects. For example, when the VR/AR glasses use a LOS path between a serving radio access node and the VR/AR glasses, and the camera identifies that a vehicle is moving in a direction towards the LoS path, a conclusion may be drawn that it is likely that the LoS path soon will be blocked by the vehicle (compare with step 144 of FIG. 1). For example, new signaling (e.g., conveyed using one or more of MAC-CE, and UCI) may be introduced in the specification to enable the VR/AR glasses to signal a warning to the network about the potential blocking event. The new signaling may be indicative of one or more of: an estimated time until the blocking event will occur (which could, for example, be estimated based on the current distance to the vehicle and the speed of the vehicle), an estimated duration of the blocking event (which could, for example, be estimated based on the size of the vehicle and the speed of the vehicle), and a candidate radio access node (e.g., a visual identifier) which has a LOS path to the VR/AR glasses that will not be affected by the blocking event. The network can use such information to mitigate the negative effects of the blocking event (e.g., by performing handover to the candidate radio access node before the blocking event starts.

The described embodiments and their equivalents may be realized in software or hardware or a combination thereof. The embodiments may be performed by general purpose circuitry. Examples of general purpose circuitry include digital signal processors (DSP), central processing units (CPU), co-processor units, field programmable gate arrays (FPGA) and other programmable hardware. Alternatively or additionally, the embodiments may be performed by specialized circuitry, such as application specific integrated circuits (ASIC). The general purpose circuitry and/or the specialized circuitry may, for example, be associated with or comprised in an apparatus such as a wireless communication device or a communication element (e.g., a radio access node) for a distributed antenna system.

Embodiments may appear within an electronic apparatus (such as a communication device) comprising arrangements, circuitry, and/or logic according to any of the embodiments described herein. Alternatively or additionally, an electronic apparatus (such as a communication device) may be configured to perform methods according to any of the embodiments described herein.

According to some embodiments, a computer program product comprises a non-transitory computer readable medium such as, for example, a universal serial bus (USB) memory, a plug-in card, an embedded drive, or a read only memory (ROM). FIG. 8 illustrates an example computer readable medium in the form of a compact disc (CD) ROM 800. The computer readable medium has stored thereon a computer program comprising program instructions. The computer program is loadable into a data processor (PROC; e.g., a data processing unit) 820, which may, for example, be comprised in a communication device 810. When loaded into the data processor, the computer program may be stored in a memory (MEM) 830 associated with, or comprised in, the data processor. According to some embodiments, the computer program may, when loaded into, and run by, the data processor, cause execution of method steps according to, for example, any of the methods illustrated in FIGS. 1 and 2, or otherwise described herein.

Generally, all terms used herein are to be interpreted according to their ordinary meaning in the relevant technical field, unless a different meaning is clearly given and/or is implied from the context in which it is used.

Reference has been made herein to various embodiments. However, a person skilled in the art would recognize numerous variations to the described embodiments that would still fall within the scope of the claims.

For example, the method embodiments described herein discloses example methods through steps being performed in a certain order. However, it is recognized that these sequences of events may take place in another order without departing from the scope of the claims. Furthermore, some method steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step.

In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer (e.g. a single) unit.

Any feature of any of the embodiments disclosed herein may be applied to any other embodiment, wherever suitable. Likewise, any advantage of any of the embodiments may apply to any other embodiments, and vice versa.

Hence, it should be understood that the details of the described embodiments are merely examples brought forward for illustrative purposes, and that all variations that fall within the scope of the claims are intended to be embraced therein.

1. A method for a communication device, wherein the communication device comprises a visual sensor, the method comprising:
using the visual sensor for detecting another communication device, wherein the other communication device is detected by distinguishing an identifier which is visually arranged on the other communication device;
estimating a direction associated with the communication device and the other communication device; and
causing subsequent communication between the other communication device and the communication device to be based on the estimated direction.

2. The method of claim 1, wherein causing subsequent communication between the other communication device and the communication device to be based on the estimated direction comprises reducing an amount of potential beams for the communication based on the estimated direction.

3. The method of any of claim 1, wherein the direction associated with the communication device and the other communication device comprises a direction from the communication device towards the other communication device.

4. The method of any of claim 1, wherein causing subsequent communication between the other communication device and the communication device to be based on the estimated direction comprises transmitting a report indicative of one or more of: a distinguished identifier, and spatial information associated with the estimated direction.

5. The method of claim 1, wherein the direction associated with the communication device and the other communication device comprises a direction from the other communication device towards the communication device.

6. The method of claim 1, wherein the other communication device is a serving radio access node for the communication device, and the method further comprises receiving a message indicative of the identifier.

7. The method of claim 6, wherein the message is configured to trigger a beam sweep of the communication device.

8. The method of claim 1 further comprising updating the estimated direction based on change in location and/or orientation of the communication device.

9. The method of claim 1 further comprising storing the estimated direction as associated with a distinguished identifier and with location and/or orientation of the communication device.

10. The method of claim 9, wherein causing subsequent communication between the other communication device and the communication device to be based on the estimated direction comprises using the stored estimated direction.

11. The method of claim 1 further comprising activating the visual sensor for device detection in response to: change in location and/or orientation of the communication device, and/or reception of an identifier indication provided from the other communication device, and/or lack of applicable stored estimated direction.

12. The method of claim 1, wherein the estimated direction associated with the communication device and the other communication device is a primary direction, the method further comprising:
using the visual sensor for locating a surface for potential radio reflection of signaling between the other communication device and the communication device;
estimating a secondary direction associated with the communication device, the other communication device, and the located surface; and
causing subsequent communication between the other communication device and the communication device to be based on the secondary estimated direction.

13. The method of claim 1 further comprising:
using the visual sensor for discovering an object for potential blocking of signaling between the other communication device and the communication device; and
transmitting an indication of the discovered object.

14. The method of claim 13, wherein the indication of the discovered object comprises a blocking start time and/or a blocking duration.

15. A computer program product comprising a non-transitory computer readable medium, having thereon a computer program comprising program instructions, the computer program being loadable into a data processing unit and configured to cause execution of the method according to claim 1 when the computer program is run by the data processing unit.

16. An apparatus for a communication device, wherein the communication device comprises a visual sensor, the apparatus comprising controlling circuitry configured to cause:
use of the visual sensor for detection of another communication device, wherein the other communication device is detected by distinguishing of an identifier which is visually arranged on the other communication device;
estimation of a direction associated with the communication device and the other communication device; and
subsequent communication between the other communication device and the communication device to be based on the estimated direction.

17.-29. (canceled)

30. A communication device comprising the apparatus of claim 16 and a visual sensor.

31. The communication device of claim 30, wherein the communication device is one or more of: a user equipment, UE; a pair of virtual reality, VR, glasses; a pair of augmented reality, AR, glasses; a vehicle; a drone; an industrial robot; and a robot for consumer use.

32. A communication device configured for communication with another communication device comprising a visual sensor, wherein the communication device has an identifier which is visually arranged on the communication device, whereby the identifier is configured to be distinguishable by the visual sensor of the other communication device for estimation of a direction associated with the other communication device and the communication device, and wherein the communication device is configured to let subsequent communication between the communication device and the other communication device be based on the estimated direction.

33.-41. (canceled)

42. The communication device of claim 32, wherein the communication device is one or more of: a radio access node; an antenna node for a distributed multiple-input multiple-output, MIMO, system; a user equipment, UE; a vehicle; a drone; and an industrial robot.
